(19) United States
(12) Patent Application Publication
(10) Pub. No.: US 2026/0098433 A1
(43) Pub. Date: Apr. 9, 2026

(54) Cargo Container Lock System and Method for Locking Cargo Containers

(71) Applicant: The Cargo Lock, LLC, Palmhurst, TX (US)

(72) Inventors: Carlton F. Martin, Palmhurst, TX (US); Frederick H. Martin, III, McAllen, TX (US)

(21) Appl. No.: 19/349,709

(22) Filed: Oct. 3, 2025

Related U.S. Application Data
(60) Provisional application No. 63/703,051, filed on Oct. 3, 2024.

(51) Int. Cl. E05B 83/02; B65D 90/00

(52) U.S. Cl. CPC E05B 83/02; B65D 90/008; B65D 2590/666

(57) ABSTRACT

Various systems and methods may be used to lock a cargo container. In one particular implementation, a method for locking a cargo container may include connecting a cable to the interior surface of at one least hinged door of a cargo container having an interior and connecting the cable to at least one interior surface of the cargo container that is not disposed on the at least one hinged door. The method may also include applying tension to the cable to pull the at least one hinged door toward the interior of the container after the at least one hinged door is closed.

### RELATED APPLICATIONS

This application is a non-provisional application claiming the benefit U.S. Provisional Ser. No. 63/703,051 , entitled “Shipping Container Lock System and Method for Locking Shipping Containers” and filed Oct. 3, 2024. This prior application is herein incorporated by reference in its entirety.

### BACKGROUND

The present disclosure relates to a system and method for locking cargo containers (e.g., intermodal freight shipping containers or semi-trailers). Specifically, it relates to a lock system that allows cargo containers to be locked from the inside.

Theft of cargo container goods is a pervasive problem in the shipping industry. Cargo containers offloaded from sea-bearing ships are often transported over land from their port of entry to destinations within a country. For example, intermodal freight shipping containers storing consumer goods may be placed on railroad cars or the cargo may be offloaded into various types of semi-trailers to transport the goods within the container to a country's interior.

Thieves often target cargo containers being transported over land to steal the goods located within the container. Thieves generally break into cargo containers when the container is stationary such as, for example, if a train or semi-trailer truck is stopped, or if the cargo container is stored at the port of entry.

Intermodal freight shipping containers generally have a uniform design. International Standard ISO 668 provides standard dimensions, tolerances, and ratings for intermodal freight shipping containers. Containers meeting this standard are known as “ISO containers.”

ISO containers are generally a rectangular box of varying lengths and heights. Close-type containers have one or more hinged doors at one end, and ISO Standard 668 sets forth minimum door opening dimensions.

Although not specified in ISO Standard 668, many intermodal shipping containers have external systems that secure the hinged doors to keep the doors from swinging open. Often, one or more vertical bars extend over the exterior of the doors to achieve this purpose. For example, FIG. 1 illustrates a shipping container 10 with three vertical bars. A first vertical bar 12 and a second vertical bar 14 extend over an exterior side 16 of a first hinged door 18. A third vertical bar 20 extends over an exterior side 22 of a second hinged door 24. These vertical bars 12, 14, 20 each have a handle 26 for moving the vertical bars 12, 14, 20 into and out of one or more receptacles 28 that are welded or otherwise affixed to a top rail 30 and/or a bottom rail 32 of the container 10 that extends along, respectively, the top and bottom periphery of the doors 18, 24.

To secure the doors 18, 24, the vertical bars 12, 14, 20 are maneuvered into their respective receptacles 28. The handle 26 is then positioned into a cradle 34 that holds the handle 26 in place so that the vertical bars 12, 14, 20 remain within their respective receptacles 28.

Locking systems to prevent unauthorized entry into a cargo container may further secure the doors of cargo containers. Often, these locking systems engage with one or more features on the exterior of the cargo container's doors. For example, the shipping container 10 in FIG. 1 may have a padlock or another locking device (not shown) engaged to prevent removal of each handle 26 from its respective cradle 34, thereby preventing disengagement of the vertical bars 12, 14, 20 from their respective receptacles 28. Additionally, the second door 24 may have a horizontally extended member 36 welded or otherwise affixed thereto which overlaps the first door 18, and a padlock or another locking device may lock the overlapping member 36 to the first door 18. Further, a commercially available horizontal locking bar (not shown) may be positioned to extend between the second vertical bar 14 and the third vertical bar 20.

Most existing cargo container door lock systems are susceptible to tampering because they are on the exterior of the container. No matter how durable the locking system, thieves can devise ways around them. For example, cargo container thieves may use bolt cutters, plasma torches, or metal grinders to disable the external locking systems. If a locking system is too robust, thieves have even been known to remove the external door hinges and, if present, cut the vertical bars to remove the doors rather than attempting to disable the locking system.

And while interior door lock systems are commercially available, these interior lock systems require extensive upgrades to the cargo container to perform properly. In general, these interior locking systems require receptacles (not shown) to be installed on the interior side of the top rail 30 and/or bottom rail 32 of the container 10 so that vertical bars (not shown) on the interior side of the doors 18, 24 can extend into the interior receptacles. Such upgrades can be time-consuming and expensive, especially if many cargo containers are involved.

Thus, there exists a need for an effective interior shipping container lock that is easy to install, and which does not require extensive upgrades. The present invention addresses such a need.

### SUMMARY

The present invention provides novel locking systems and methods for cargo containers. Moreover, various aspects of the novel systems and methods may be patentable unto themselves.

In a broad form, a system and method for locking a cargo container may use one or more cables to exert a force that pulls the cargo container's doors inward. The term cable is used in its broadest form and may include a length of chain, a rope, a strap, or any other elongate structure, including one having multiple segments, that may be used to pull the cargo container's doors inward. The one or more cables may be anchored to at least one interior surface that is not disposed on the cargo container doors, hereinafter referred to as an “off-door anchor.” The off-door anchor may comprise an existing structure within the container known as a “lashing ring,” or may be added to an interior surface of the container that is not disposed on the container doors. The one or more cables may extend from one or more off-door anchor(s) to one or more anchors on an interior surface of the doors, herein after referred to as “on-door anchors.” Force is then applied to the one or more cables to put the cable(s) under tension, which pulls the doors inward.

In one general aspect, a cargo container locking system may include a pulling device, a first coupler, and a second coupler. The pulling device (e.g., a winch) includes a cable having a distal end extendable from the pulling device and retractable toward the pulling device. The first coupler is adapted to connect the cable to an interior surface of a first hinged door of a cargo container, and the second coupler is adapted to connect the distal end of the cable to an interior surface of a first wall of a cargo container. The second coupler may be positionable such that the first door of the cargo container is pulled toward the interior of the cargo container after the door is closed and the pulling device maintains the cable in tension.

Certain implementations may include a third coupler adapted to connect the pulling device to an interior surface of the cargo container which is not disposed on the first hinged door. The third coupler may be positionable in the cargo container such that the first hinged door of the cargo container is pulled toward the interior of the cargo container after the door is closed and the pulling device maintains the cable in tension.

Particular implementations may include a fourth coupler adapted to connect the cable to a second hinged door of the cargo container. The fourth coupler may, for example, be an eye & jaw swivel.

Some implementations may include a fifth coupler, a sixth coupler, and a seventh coupler. The fifth coupler may be adapted to connect the cable to an interior surface of a second wall of the storage container and to redirect the direction of the cable (e.g., from a horizontal direction to a vertical direction, from a vertical direction to a horizontal direction, or while maintaining the cable in a horizontal plane changing the cable direction from a first horizontal direction to a second horizontal direction such as, for example, if the cable extended in a first direction horizontally along a side wall of the container and was redirected to extend in a second direction horizontally across one or more container doors). The sixth coupler may be adapted to also connect the cable to the second hinged door, and the seventh coupler may be adapted to also connect the cable to the first hinged door.

In another general aspect, a cargo container locking system may include a cargo container, at least one cable, and a pulling device. The cargo container may include a front wall, a first side wall, a second side wall, a top wall, a bottom wall, and at least one hinged door opposite the front wall. The front wall, the first side wall, the second side wall, the top wall, the bottom wall, and, when closed, the at least one hinged door may define an interior for the container. The at least one cable may be connected to the interior surface of the at least one hinged door and to at least one interior surface of the cargo container, the at least one interior surface not being disposed on the at least one hinged door. The pulling device may be adapted to put the at least one cable under tension between the connection of the at least one cable to the at least one hinged door and the at least one interior surface of the container.

The at least one cable may be connected to the interior surface of the at least one hinged door through at least one on-door anchor and may be connected to the at least one interior surface of the container through at least one off-door anchor. In certain implementations, the at least one on-door anchor may comprise a plurality of on-door anchors, and the at least one off-door anchor may comprise a plurality of off-door anchors.

The system may also include a first coupler to connect the cable to the at least one hinged door and a second coupler to connect a distal end of the cable to the interior surface of a first one of the walls. The cable may extend from the pulling device, with its distal end being extendable away from the pulling device when the pulling device is not activated and retractable toward the pulling device when the pulling device is activated. The second coupler may be positioned so that the at least one hinged door is pulled toward the interior of the cargo container after the door is closed and the pulling device maintains the cable in tension. The second coupler may, for example, be an eye & jaw swivel.

The locking system may also include a third coupler adapted to connect the pulling device to an interior surface of the cargo container which is not on the first hinged door. The third coupler may be positioned so that the at least one hinged door of the cargo container is pulled toward the interior of the cargo container after the door is closed and the pulling device maintains the cable in tension.

In some implementations, the cargo container may include a second hinged door opposite the front wall and a fourth coupler that connects the cable to the second hinged door. The locking system may also include a fifth coupler, a sixth coupler, and a seventh coupler. The fifth coupler may connect the cable to the interior surface of a second one of the walls and be adapted to redirect the cable's direction, and the sixth coupler may also connect the cable to the second door. The seventh coupler may also connect the cable to the interior surface of the first door.

In another general aspect, a method for locking a cargo container may include connecting a cable to the interior surface of at one least hinged door of the cargo container and to at least one interior surface of the cargo container that is not disposed on the at least one hinged door. The method may also include applying tension to the cable to pull the at least one hinged door toward an interior of the container after the at least one hinged door is closed.

Connecting a cable to the at one least hinged door of a cargo container and to at least one interior surface of the container that is not disposed on the at least one hinged door may include extending the cable through a first coupler adapted to connect the cable to the at least one hinged door and connecting a distal end of the cable to the at least one interior surface of the cargo container. Applying tension to the cable to pull the at least one hinged door toward the interior of the shipping container after the at least one hinged door is closed may include activating a pulling device located within an interior of the container to tighten the cable.

The method may also include extending the cable through a second coupler adapted to connect the cable to a second hinged door of the cargo container. The cable may pull the second hinged door toward the interior of the container after the at least one hinged door is closed.

The method may further include extending the cable through a third coupler connected to an interior surface of a cargo container, wherein the third coupler is adapted to redirect the direction of the cable before extending the cable through the first coupler that is connected to the first hinged door. The method may also include extending the cable through a fourth coupler also connected to the second hinged door and extending the cable through a fifth coupler also connected to the first hinged door. The method may further include extending the cable through a sixth coupler adapted to redirect the direction of the cable before extending the cable through the fourth coupler on the second hinged door.

In an additional general aspect, a cargo container locking system may include a cargo container, a pulling device, a first coupler, and a second coupler. The cargo container may include a front wall, a first side wall, a second side wall, a top wall, a bottom wall, and at least one hinged door opposite the front wall. The front wall, the first side wall, the second side wall, the top wall, the bottom wall, and, when closed, the at least one hinged door may define an interior of the container. The pulling device may include a cable having a distal end extendable from the pulling device and retractable toward the pulling device. The first coupler (e.g., an eye and jaw swivel) may connect the cable to the interior surface of the at least one hinged door, and the second coupler may connect the distal end of the cable to the interior surface of a first one of the walls. The pulling device and/or the second coupler may be positioned within the interior of the cargo container relative to the first hinged door such that the at least one hinged door is pulled toward the interior of the cargo container after the door is closed by the pulling device applying force on the door through the cable or otherwise.

The cargo container may also include a second hinged door opposite the front wall and a third coupler that connects the cable to the second hinged second door. The third coupler may be positioned relative to the pulling device and/or the second coupler such that the second hinged door is pulled toward the interior of the cargo container after the door is closed by the retracting of the cable and tension is maintained therein.

The locking system may also include a fourth coupler that connects the cable to the interior surface of a second one of the walls, with the fourth coupler being adapted to redirect the cable's direction and a fifth coupler that also connects the cable to the second hinged door. A sixth coupler may also connect the cable to the first hinged door.

Various implementations may have one or more features. For example, a cargo container locking system and method in accordance with the present invention may provide a way to secure one or more doors of a cargo container, thus keeping the contents safer. Additionally, the locking system and method may make it difficult for thieves to tamper with the system (e.g., by being completely internal to the cargo container). Other aspects and advantages of the present invention may be obtained from a study of this disclosure and the drawings, along with the appended claims.

### BRIEF DESCRIPTION OF THE DRAWINGS

FIG. 1 is a line drawing illustrating a back elevation view of an example cargo container.

FIG. 2 is a line drawing illustrating an internal front elevation view of a first example locking system for a cargo container in accordance with the present invention while in a locked mode.

FIG. 3 is a line drawing illustrating a top perspective view of components of the first example locking system while in an unlocked mode.

FIG. 4 is a line drawing illustrating a top perspective view of additional components of the first example locking system while in an unlocked mode.

FIG. 5 is a line drawing illustrating a top perspective view of further components of the first example locking system while in an unlocked mode.

FIG. 6 is a line drawing illustrating a bottom perspective view of additional components of the first example locking system while in an unlocked mode.

FIG. 7 is a line drawing illustrating a bottom perspective view of further components of the first example locking system while in an unlocked mode.

FIG. 8 is a line drawing illustrating a bottom perspective view of additional components of the first example locking system while in an unlocked mode.

FIG. 9 is a line drawing illustrating a top perspective view of further components of the first example locking system while in an unlocked mode.

FIG. 10 is a line drawing illustrating another example locking system for a cargo container in accordance with another embodiment of the present invention while in an unlocked mode.

FIG. 10A is a line drawing illustrating the front of the cargo container in FIG. 10.

FIGS. 11-11A are line drawings illustrating an example retrofitting for an on-door anchor for the embodiment in FIG. 10.

FIG. 12 is a line drawing illustrating an example coupler for the embodiment in FIG. 10.

FIG. 13 is a line drawing illustrating the details for an off-door anchor for the embodiment in FIG. 10.

FIG. 14 is a line drawing illustrating the details for another example off-door anchor for the embodiment in FIG. 10.

FIG. 15 is a line drawing illustrating the details of the pulling device mounting for the embodiment in FIG. 10.

### DETAILED DESCRIPTION

Various embodiments of the invention will be discussed, mentioned, and/or suggested below. The invention, however, is broader than any particular embodiment. Moreover, various aspects of various embodiments may be used with each other. For example, an embodiment for a locking system for a shipping container is discussed in detail, and an embodiment for locking system for a semi-trailer is also discussed in detail. But various aspects from each embodiment may be used with each other. Moreover, various aspects may be used with any type of cargo container. Thus, the following discussion should not be viewed as limiting the invention to the components and/or configurations discussed therein.

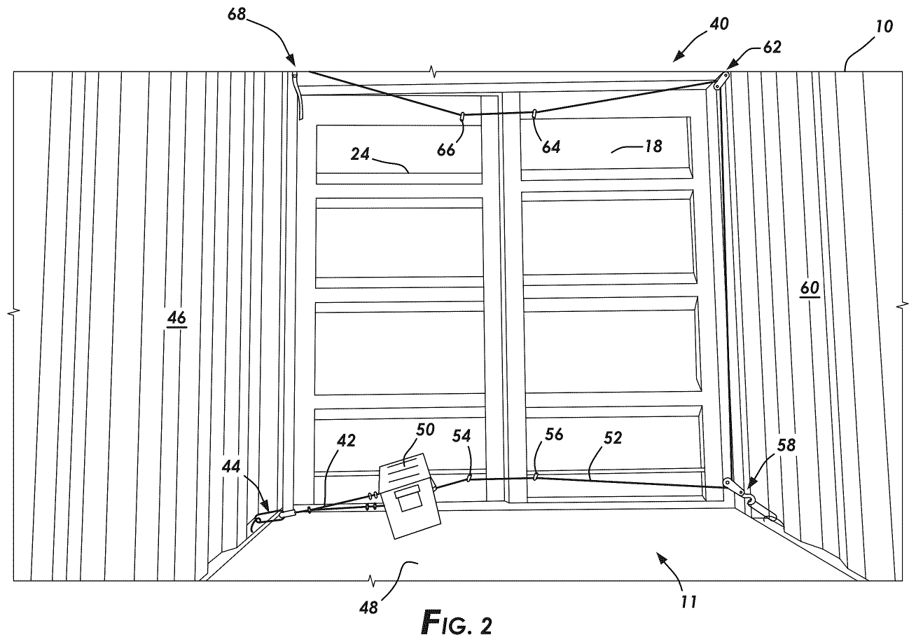

FIG. 2 is a front elevation view from within a cargo container 10 that illustrates a locking system 40 in accordance with the present invention that is in use to lock the first and second doors 18, 24. As illustrated, the cargo container 10 includes a first door 18, a second door 24, a first side wall 46, a second side wall 60, and a floor 48 which define an interior 11 of the container. The cargo container typically also includes a ceiling (not shown) and a front wall (not shown). The first door 18, the second door 24, the first side wall 46, the second side wall 60, and the floor 48 are shown from the interior 11 of the cargo container 10 in FIG. 2.

A first cable 42 extends from a first off-door anchor 44 located near the intersection of the first side wall 46 of the container 10 and the floor 48 of the container 10. The first cable 42 extends to a winch storage box 50 positioned on the container floor 48.

A second cable 52 extends from the winch storage box 50 to a first on-door anchor 54 located on the second door 24. The second cable 52 extends from the first on-door anchor 54 to a second on-door anchor 56 located on the first door 18, from the second on-door anchor 56 to a second off-door anchor 58 located near the intersection of the second side wall 60 of the container 10 and the container floor 48, from the second off-door anchor 58 to a third off-door anchor 62 located near the intersection of a ceiling (not shown) of the container 10 and the second container side wall 60, from the third off-door anchor 62 to a third on-door anchor 64 located on the first door 18, from the third on-door anchor 64 to a fourth on-door anchor 66 located on the second door 24, and from the fourth on-door anchor 66 to a fourth off-door anchor 68 located near the intersection of the container ceiling (not shown) and the first container side wall 46.

As shown in FIG. 2, the winch storage box 50 is canted such that a bottom surface of the box 50 is not entirely on the container floor 48. Canting of the winch box 50 is due to tension in the first cable 42 and the second cable 52 caused by a winch (not shown) within the box 50 pulling on the cables 42, 52.

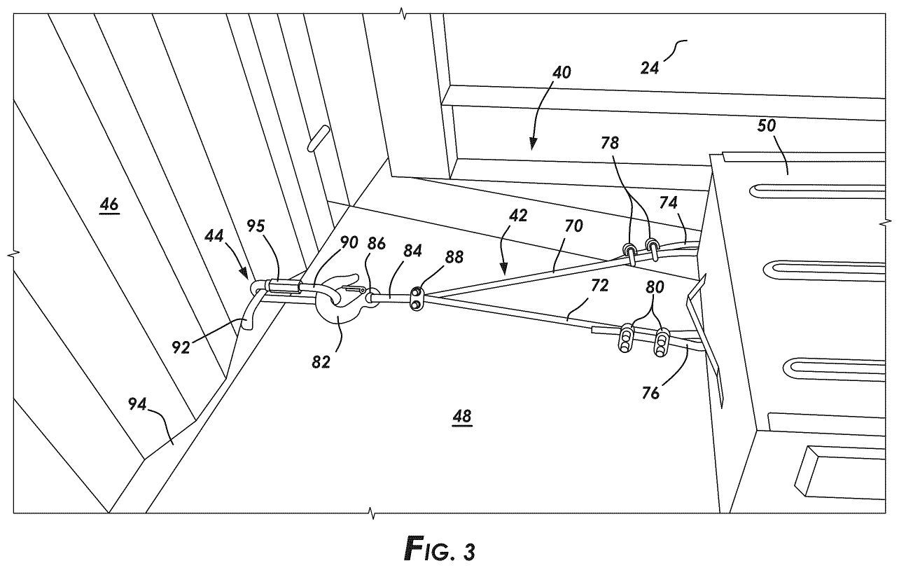

FIG. 3 is a top perspective view of various components of the locking system 40 while not in tension. In particular, FIG. 3 illustrates the first cable 42 and the winch storage box 50. In the illustrated embodiment, the first cable 42 comprises five-sixteenths inch ( 5/16″) diameter steel wire rope with a working load limit of 1960 lbs. However, different types and sized cables, along with differing working load limits, are contemplated. As shown, first cable 42 comprises a first leg 70 and a second leg 72, with both legs 70, 72 extending into the winch storage box 50.

The first cable 42 has a first loop 74 and a second loop 76 extending into the winch storage box 50. The first loop 74 is formed by doubling the first leg 70 back on itself and installing a first set of wire clamps 78. The second loop 76 is formed by doubling the second leg 72 back on itself and installing a second set of wire clamps 80.

The first and second legs 70, 72 of the first cable 42 extend to a cable hook 82 connected to the first cable 42. The first cable 42 has a third loop 84 that extends through an eyelet 86 of the fixed-eye cable hook 82. The third loop 84 is formed by doubling the cable 42 back on itself and installing a wire clamp 88 that holds the first and second legs 70, 72 together. Additionally, although the eyelet 86 is closed in the embodiment 40, the cable hook 82 may optionally comprise a yoke and clevis arrangement in place of the eyelet 86. The first cable 42 is connected to the first off-door anchor 44 through the cable hook 82.

The first off-door anchor 44 is any structure that connects the first cable 42 to one or more interior surfaces of the container 10 which are not disposed on the first or second doors 18, 24 and which will withstand the forces when tension is applied to the second cable 52 (not shown) to lock the first and second doors 18, 24. In the embodiment 40, the cable hook 82 is hooked onto a coupler 90 (e.g., a chain quick link) that extends through the first off-door anchor 44 near the intersection of the first container side wall 46 and the container floor 48. In the embodiment 40, the first off-door anchor 44 comprises a lashing ring 92 welded or otherwise affixed to a horizontal beam 94 located at the intersection of the first container side wall 46 and the container floor 48. The coupler 90 has an internally threaded nut 95 that can be loosened to open the coupler 90 and connect the coupler 90 to the lashing ring 92.

It should be noted that different configurations of the first cable 42 and the connection of the first cable 42 to the first off-door anchor 44 are contemplated. For example, one or more of the wire clamps may be repositioned, not present, and/or replaced by one or more ferrules (not shown) to form any of the loops 74, 76, 84. The first and/or second loops 74, 76 also may be replaced by hooks. Additionally, chain quick link coupler 90 may not be present if the cable hook 82 connects directly to the first off-door anchor 44, or may be replaced with a spring link (not shown), an S-hook (not shown), or some other coupled connection. The cable hook 82 may also not be present if the first cable 42 connects directly to the first off-door anchor 44 such as, for example, if the first cable 42 extended through the lashing ring 92.

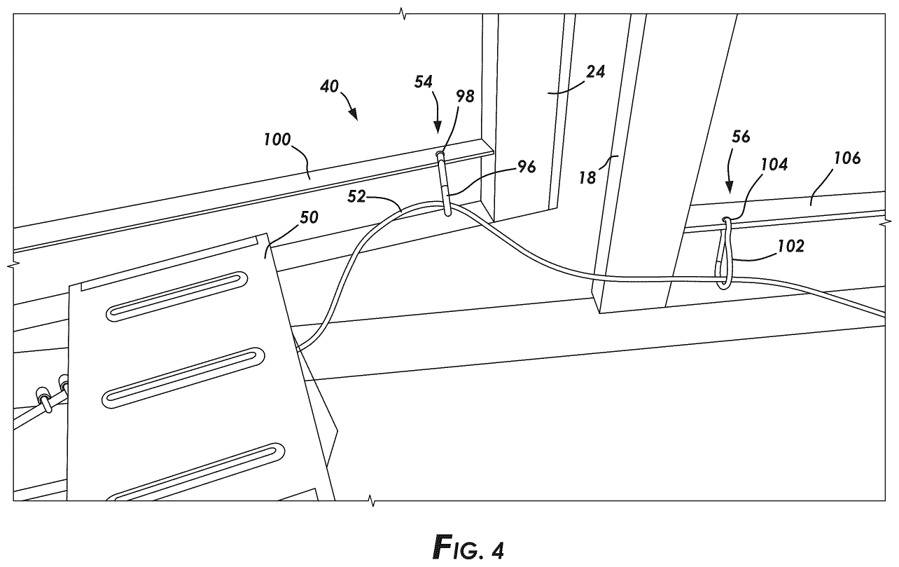

FIG. 4 is a top perspective view of another portion of the embodiment 40 that shows the second cable 52 extending from the winch storage box 50 while not in tension. As shown, the second door 24 is slightly open. The second cable 52 is connected to the first on-door anchor 54. The first on-door anchor 54 is any structure that connects the second cable 52 to the second door 24 and will withstand the forces when tension is applied to the second cable 52 to lock the first and second doors 18, 24. In the embodiment 40, the first on-door anchor 54 comprises an aperture 98 bored into an interior cross member 100 of the second door 24. A coupler 96 (e.g., a spring link) connects the cable 52 to the anchor 98. Alternatively, spring link coupler 96 may be replaced with a variety of other coupled connections (e.g., a traditional hook, an S-hook, a chain quick link, etc.) or the second cable 52 may be threaded directly through the aperture 98.

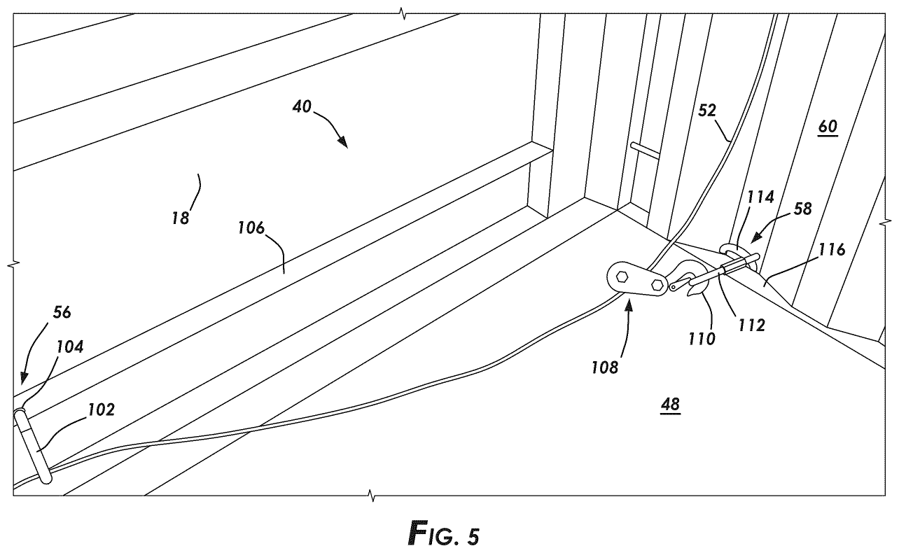

The second cable 52 extends from the first on-door anchor 54 to the second on-door anchor 56 that is located on the first door 18. The second on-door anchor 56 is any structure that connects the second cable 52 to the first door 18 and will withstand the forces when tension is applied to the second cable 52 to lock the first and second doors 18, 24. As best shown in FIG. 5, in the embodiment 40, the second on-door anchor 56 comprises an aperture 104 bored into an interior cross member 106 of the first door 18. A coupler 102 (e.g., a spring link) connects the cable 52 to the on-door anchor 56. Alternatively, spring link coupler 102 may be replaced with a variety of other coupling devices (e.g., a traditional hook, an S-hook, a chain quick link, etc.) or the second cable 52 may be threaded directly through the aperture 104.

FIG. 5 is a top perspective view of another aspect of the embodiment 40 that shows the second cable 52 while not in tension connected to the second on-door anchor 56 that is located on the first door 18. The second cable 52 extends from the second on-door anchor 56 to a pulley 108 connected to a hook 110. The second cable 52 extends through the pulley 108 and up the second container side wall 60 in a direction toward the container ceiling (not shown). The second cable 52 is connected to the second off-door anchor 58 through the pulley 108/hook 110 connection.

The second off-door anchor 58 is any structure that connects the second cable 52 to one or more interior surfaces of the container 10 which are not disposed on the first or second doors 18, 24 and which will withstand the forces when tension is applied to the second cable 52 to lock the first and second doors 18, 24. In the embodiment 40, the hook 110 connects to a coupler 112 (e.g., a chain quick link) that extends through the second off-door anchor 58. In the embodiment 40, the second off-door anchor 58 comprises a lashing ring 114 welded or otherwise affixed to a horizontal beam 116 located at the intersection of the second container side wall 60 and the container floor 48.

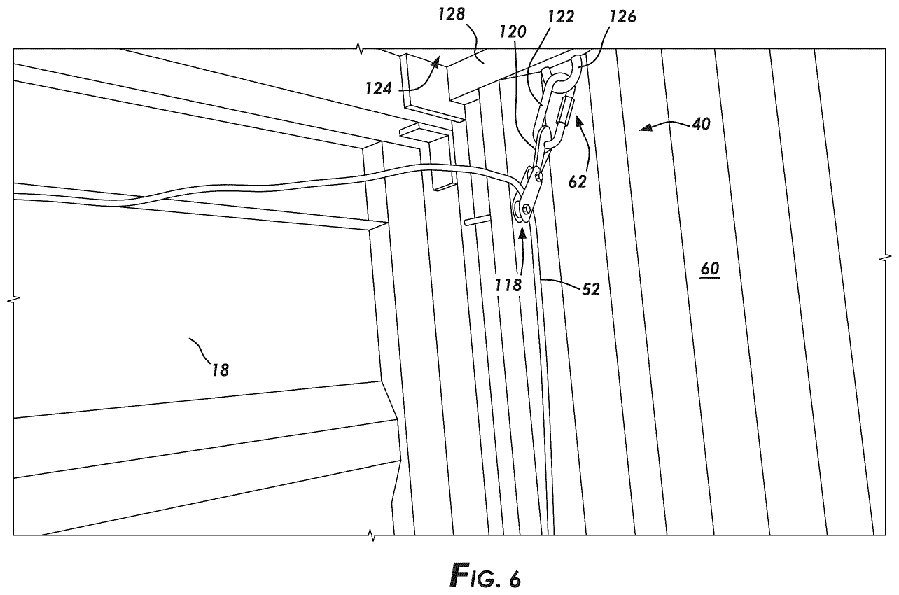

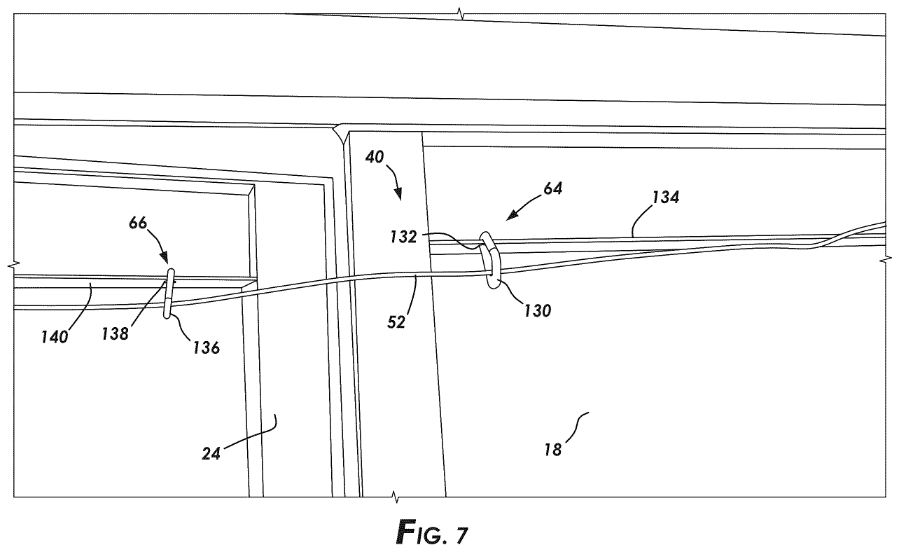

FIG. 6 is a bottom perspective view of another aspect of the embodiment 40 that shows the second cable 52 while not in tension connected to the third off-door anchor 62. The second cable 52 extends from the second off-door anchor 58 (see FIG. 5) to a pulley 118 that is connected to a hook 120. The second cable 52 extends through the pulley 118 and then laterally toward the third on-door anchor 64 (see FIG. 7) on the first door 18.

The third off-door anchor 62 is any structure that connects the second cable 52 to one or more interior surfaces of the container 10 which are not disposed on the first or second doors 18, 24 and will withstand the forces when tension is applied to the second cable 52 to lock the first and second doors 18, 24. In the embodiment 40, the hook 120 connects to a coupler 122 (e.g., a chain quick link) that extends through the third off-door anchor 62. In the embodiment 40, the third off-door anchor 62 comprises a lashing ring 126 welded or otherwise affixed to a horizontal beam 128 located at the intersection of the second container side wall 60 and the container ceiling 124.

FIG. 7 is a bottom perspective view of an additional aspect of the embodiment 40 that shows the second cable 52 while not in tension connected to the third on-door anchor 64 that is located on the first door 18 and the fourth on-door anchor 66 that is located on the second door 24. The second cable 52 extends from the third off-door anchor 62 (see FIG. 6) laterally to the third on-door anchor 64, and from the third on-door anchor 64 laterally to the fourth on-door anchor 66.

The second cable 52 is connected to the third on-door anchor 64. The third on-door anchor 64 is any structure that connects the second cable 52 to the second door 24 and will withstand the forces when tension is applied to the second cable 52 to lock the first and second doors 18, 24. In the embodiment 40, the cable 52 is connected to the on-door anchor via a coupler 130 (e.g., a spring link) inserted through an aperture 132 bored into an interior cross member 134 of the first door 18. Alternatively, spring link coupler 130 may be replaced with a variety of connections (e.g., a traditional hook, an S-hook, a chain quick link, etc.) or the second cable 52 may be threaded directly through the aperture 132.

The second cable 52 also is connected to the fourth on-door anchor 66 on the second door 24. The fourth on-door anchor 66 is any structure that connects the second cable 52 to the second door 24 and will withstand the forces when tension is applied to the second cable 52 to lock the first and second doors 18, 24. In the embodiment 40, the cable 52 is connected to the on-door anchor via a coupler 136 (e.g., a spring link) inserted through an aperture 138 bored into an interior cross member 140 of the second door 24. Alternatively, spring link coupler 136 may be replaced with a variety of connections (e.g., a traditional hook, an S-hook, a chain quick link, etc.) or the second cable 52 may be threaded directly through the aperture 138.

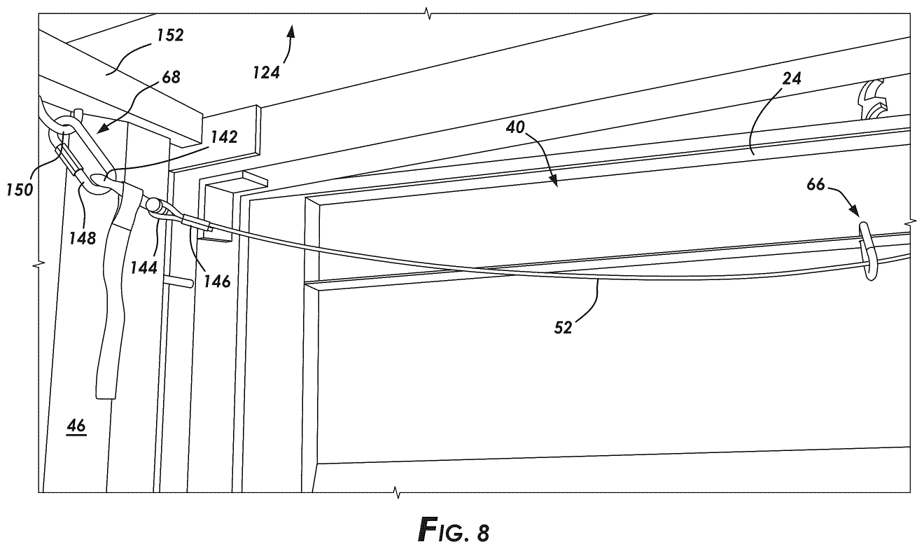

FIG. 8 is a bottom perspective view of the embodiment 40 that shows the second cable 52 while not in tension connected to the fourth off-door anchor 68. The second cable 52 extends from the fourth on-door anchor 66 laterally toward the fourth off-door anchor 68. The second cable 52 is connected to the fourth off-door anchor 68 through a hook 142 that is located at a looped end 144 of the second cable 52. The looped end 144 is formed by first inserting the second cable 52 through an eyelet on the hook 142 and then doubling the second cable 52 back on itself. A ferrule 146 is then installed to fix the looped end 144 in place.

The fourth off-door anchor 68 is any structure that connects the second cable 52 to one or more interior surfaces of the container 10 which are not disposed on the first or second doors 18 24 and will withstand the forces when tension is applied to the second cable 52 to lock the first and second doors 18, 24. In the embodiment 40, the hook 142 connects to a coupler 148 (e.g., a chain quick link) that extends through the fourth off-door anchor 68. In the embodiment 40, the fourth off-door anchor 68 comprises a lashing ring 150 welded or otherwise affixed to a horizontal beam 152 located at the intersection of the first container side wall 46 and the container ceiling 124.

It should be noted that different connections of the second cable 52 to the various on-door and off-door anchors are contemplated. For example, one or more of the hooks may not be present such as, for example, if the second cable 52 extended directly through the on-door and/or off-door anchors. Additionally, the one or more couplers may not be present if the hooks hook directly onto the first off-door anchors, or may be replaced with a spring link (not shown), an S-hook (not shown), or some other coupled connection.

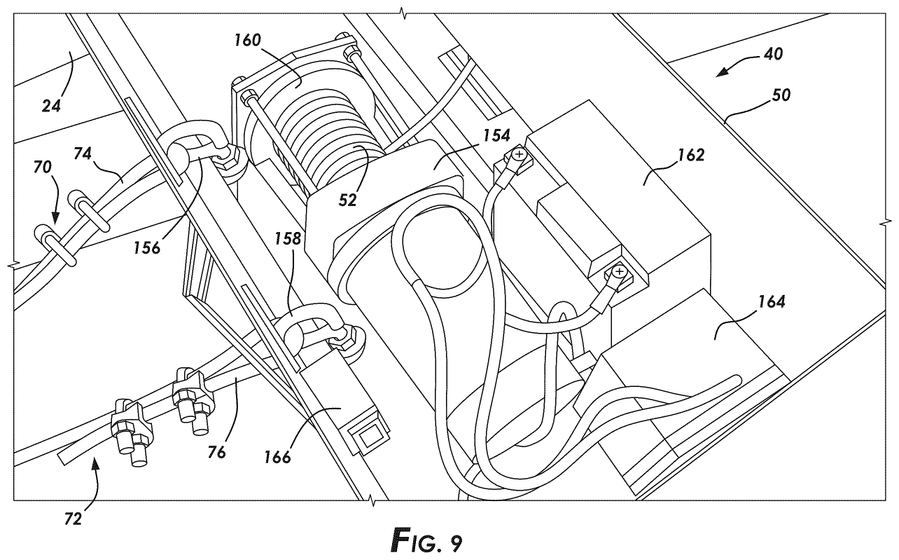

FIG. 9 shows a top perspective view of an additional portion of the embodiment 40 while not in tension that illustrates the winch storage box 50 in an open state. In FIG. 9, the lid (not shown) of the winch storage box 50 is opened to illustrate a winch 154 contained therein. As shown, the first loop 74 in the first leg 70 of the first cable 42 is connected around a first anchor post 156 extending from the winch 154 and the second loop 76 in the second leg 72 of the first cable 42 is connected around a second anchor post 158 extending from the winch 154. The second cable 52 comprises the winch line and is wrapped around a rotating drum 160 of the winch 154.

The winch 154 is connected to a power source such as a battery 162 that provides power and a receiver 164 that receives commands from a transmitter (not shown). In operation, the transmitter wirelessly transmits commands to the receiver 164. The commands instruct the winch 154 to rotate the drum 160 clockwise or counterclockwise, thereby tightening or loosening the second cable 52. Tightening of the second cable 52 creates tension in the first and second cables 42, 52 which pulls the first and second doors 18, 24 (not shown) inward, thereby locking the doors 18, 24 from the interior of the container 10. More specifically, the tension in the cables 42, 52 pulls the doors 18, 24 from one or more interior surfaces of the container which are not disposed on the doors 18, 24. Additionally, the doors 18, 24 continue to be pulled inward after they are closed.

The winch 154 can be a variety of winch types. It has been found, for example, that the Stimulator/Stegodon “Jungle Explorer” model twelve-volt steel cable ATV winch with a 3000 lb. maximum rated line pull has proven effective. This model has a three sixteenths inch ( 3/16″) diameter steel wire ropes, and is equipped with a wireless remote (not shown) and a wired manual switch 166 that manually controls activation of the winch 154.

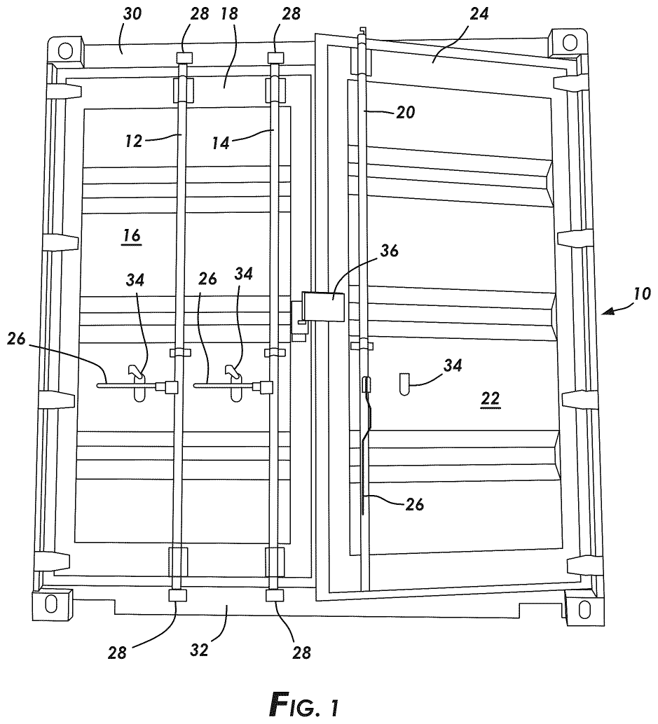

Although FIGS. 1-9 illustrate an example locking system for a cargo container, other configurations are possible. For example, a locking system may have more on-door anchors (e.g., 6, 8, or 12) or fewer (e.g., 1, 2, or 3). Additionally, redirecting couplers (like pulley 108) are not required. In some implementations, the cable may be directly connected to an anchor, for example. Additionally, winch box 50 may be suspended (e.g., from a side wall or the ceiling) in some implementations.

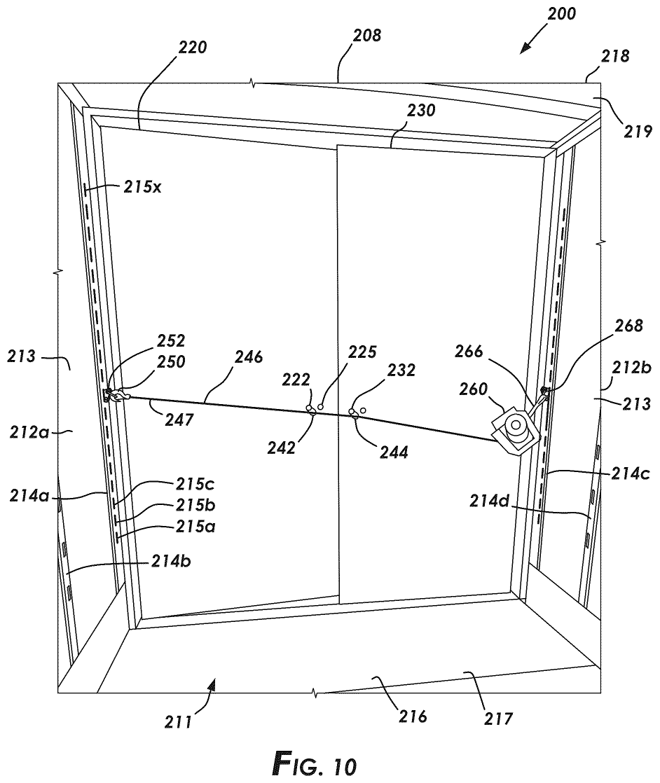

FIG. 10 illustrates a locking system 200 for a cargo container 208 in accordance with a second embodiment of the present invention. As illustrated, cargo container 208 is a semi-trailer. However, various aspects of locking system 200 could be implemented on any other type of cargo container (e.g., a shipping container).

As shown in FIGS. 10-10A, cargo container 208 includes a front wall 210, a first side wall 212a, a second side wall 212b, a bottom wall 216, a top wall 218, and a first hinged door 220 and a second hinged door 230, which are opposite the front wall. Together, the front wall 210, the side wall 212a, the side wall 212b, the bottom wall 216, the top wall 218, and, when closed, the first hinged door 220 and the second hinged door 230 define an interior 211 of the cargo container 208. Thus, the front wall 210, the first side wall 212a, the second side wall 212b, the bottom wall 216, the top wall 218, the first hinged door 220, and the second hinged door 230 may each have an interior surface facing the interior 211 of the cargo container 208. For example, each side wall 212a, 212b has an interior surface 213, the bottom wall 216 has an interior surface 217, and the top wall 218 has an interior surface 219. The interior surface 217 of the bottom wall 216 may, for example, form the floor of the cargo container, and the interior surface 219 of the top wall 218 may form the ceiling of the cargo container.

As illustrated, the interior surface 213 of each side wall 212 includes a number of anchor mechanisms 214 spaced longitudinally along the respective wall, with each anchor mechanism 214 having a number of apertures 215 for receiving an anchor 252, 268. In particular implementations, anchor mechanisms 214 may be vertical e-tracks, but other anchor mechanisms are contemplated (e.g., horizontal e-tracks, vertically aligned lashing rings, etc.). Or a cargo container may only have one anchor in a particular area.

Doors 220, 230 are respectively hinged to side wall 212a and side wall 212b so that the doors open outward and include at least one anchor 222, 232. Anchor 222, 232 may be originally manufactured into doors 220, 230 or, as discussed below, may be retrofitted thereinto. Anchor 222, 232 may, for example, be loops, rings (whether square, round, D, or otherwise), or other any other mechanism that can receive a coupler, or possibly even a cable.

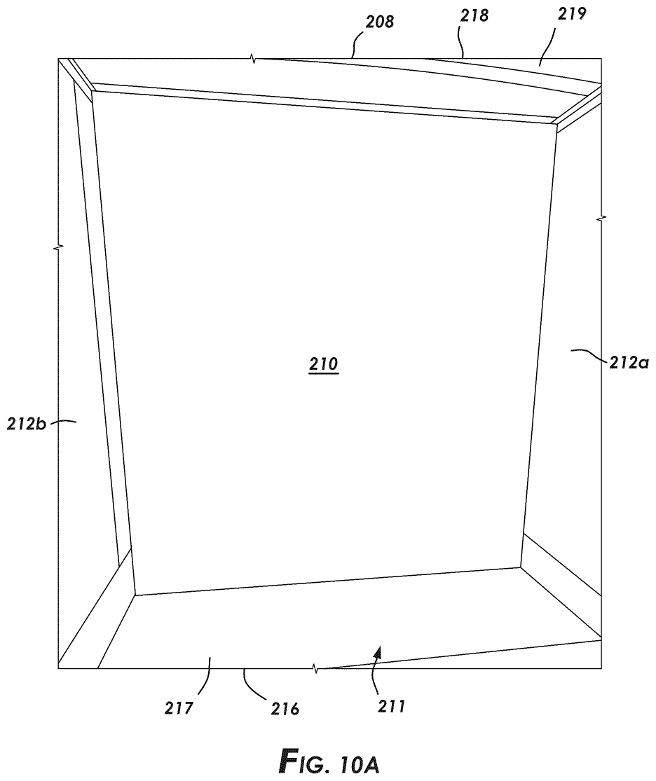

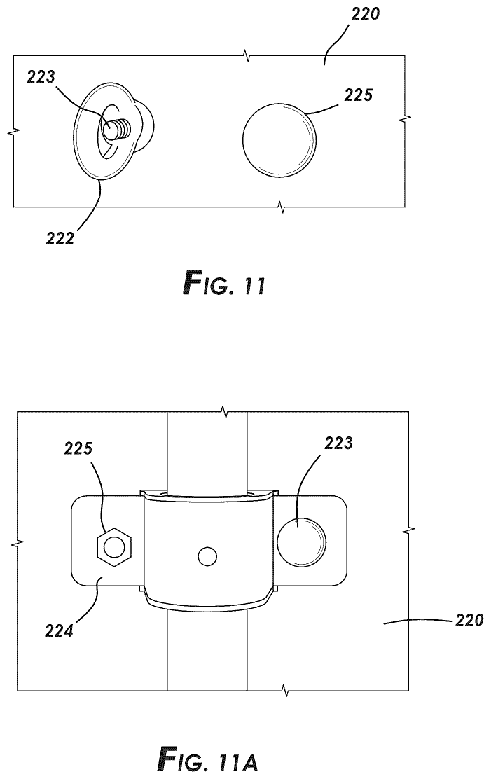

FIGS. 11-11A illustrate a retrofitting of the anchor 222 onto door 220 for the current implementation. In this implementation, anchor 222 is an eye nut and is coupled to the door 220 via a bolt 223. Bolt 223 is installed in the door 220 by removing one of the bolts 225 that secures an external clamp 224 to the door 220 and replacing the removed bolt with bolt 223 such that the at least some of the threads of bolt 223 are positioned within the interior of the cargo container. The anchor 222 may then be screwed onto the portion of the bolt 223 extending into the interior 211 of the cargo container 208, as shown, for example, in FIG. 11. Other installations for the bolt 223 are possible (e.g., drilling a hole in the door).

Referring back to FIG. 10, connected to anchors 222, 232 are couplers 242, 244. Couplers 242, 244 may be carabiners, eye and jaw swivels, pulley blocks with hooks, or any other type of devices that may couple to anchors 222, 232 and allow a cable 246 to extend therethrough. In particular implementations, the cable may be received by the anchors themselves.

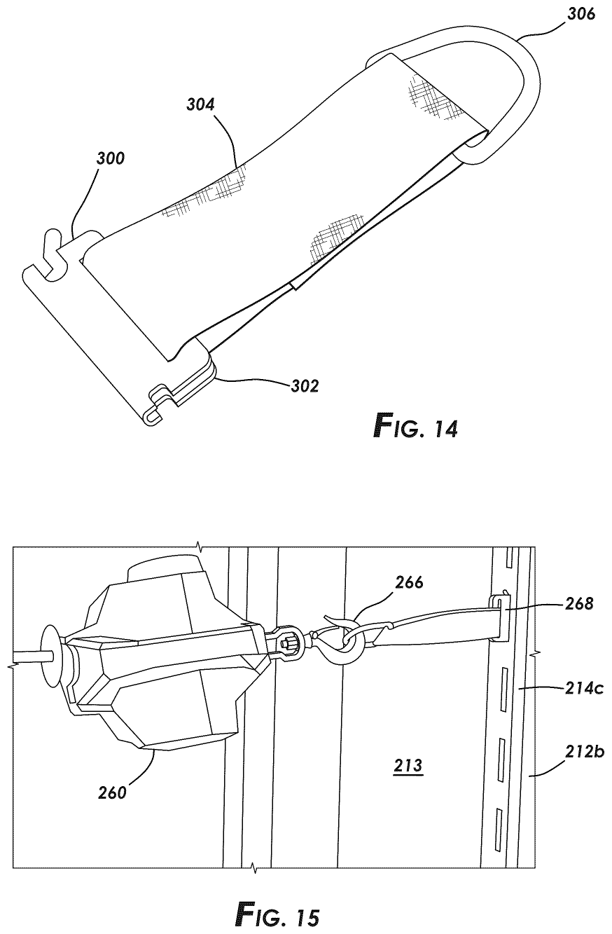

FIG. 14 illustrates an eye and jaw swivel 310 that may be used as one of couplers 242, 244. As its name implies, eye and jaw swivel 310 includes a jaw 312 and an eye 316 that are connected by a swivel 314. Jaw 312 includes a pin 313 that may be opened (e.g., via sliding or swinging) to connect to an anchor in the cargo container 208. The cable 246 may extend through eye 316, with the swivel 314 allowing the eye 316 to adjust in direction to receive the cable 246 and when the cable 246 is placed into tension.

Referring again to FIG. 10, the cable 246 provides a pulling force towards the interior 211 of the cargo container 208 when tensioned. As illustrated, the cable 246 is one piece, but it may have multiple segments in other implementations.

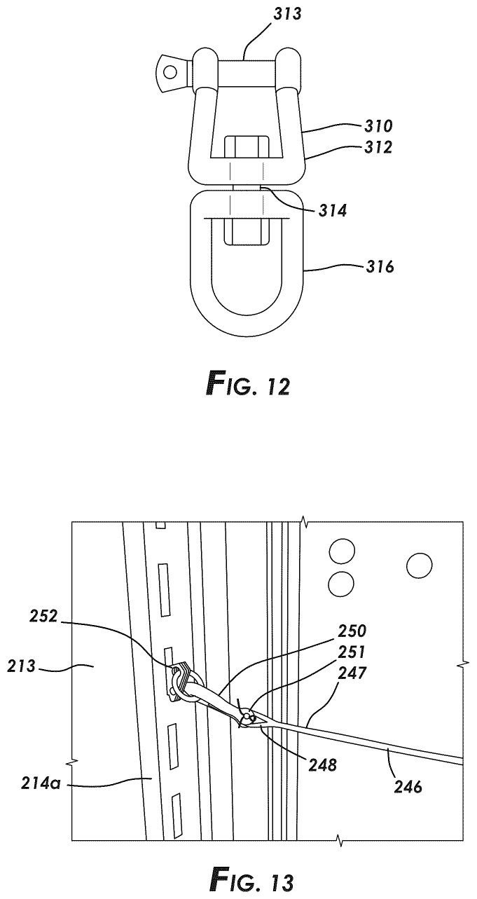

Cable 246 has a distal end 247 at which it connects to the interior surface 213 of the side wall 212a of cargo container 208 via coupler 250. A detailed view of this connection may be seen in FIG. 13.

As illustrated, the distal end 247 of the cable 246 is connected to coupler 250 by having an eye 248 (e.g., a Flemish eye splice) formed at the distal end. The eye 248 is received in a jaw 251 of coupler 250, which has a snap hook on the other end. The distal end 247 of the cable 246 could, however, have other configurations, and the coupler 250 could be another type of fastener (e.g., a carabiner) in other implementations.

Also as illustrated, the anchor 252 is on the interior surface 213 of side wall 212a and is an e-track o-ring anchor. Thus, the anchor 252 is movable between the apertures in locking mechanism 214a to adjust the anchor location vertically for distal end 247 of the cable 246. Moreover, the anchor 252 is movable between locking mechanism 214a and locking mechanism 214b (see FIG. 10) to adjust horizontally the anchor location for distal end 247 of the cable 246. However, anchor 252 may have other configurations in other implementations (e.g., a lashing ring or a permanently mounted O-ring).

FIG. 14 illustrates an alternate anchor 300 for use with the locking system 200. The anchor 300 includes a fitting 302 for connecting to an e-track rail and a strap 304 with a D-ring 306 at the end opposite the fitting 302. While the anchor 300 may be weaker than the anchor 252, the anchor 300 may provide more mounting directions than the anchor 252.

Referring back to FIG. 10, at the end opposite the distal end 247, the cable 246 extends from a pulling device 260. Pulling device 260 is electrically powered and is operable to increase and decrease the tension in the cable 246 (e.g., to provide an inward pulling force on the doors 220, 230). In particular implementations, pulling device 260 is operated by remote control via a wireless interface (e.g., Bluetooth, wireless Ethernet, infrared, or a proprietary wireless protocol) and/or a wired interface.

As best shown in FIG. 15, pulling device 260 may be connected to the side wall 212b via a coupler 266 and an anchor 268. As illustrated, coupler 266 is composed of a hook with a swiveling jaw. However, coupler 266 may have other configurations in other implementations (e.g., an eye and jaw coupler, a carabiner, or a strap).

Pulling device 260 may, for example, have a rotating drum around which the proximal end of the cable 246 is wound. The pulling device may be connected to a power source such as a battery or a wiring harness (not shown) of the cargo container to provide power for rotating the drum. The pulling device may also have a receiver that receives commands from a transmitter (not shown). In operation, the transmitter may transmit commands (via a wired or wireless connection) to the receiver. The commands instruct the pulling device to rotate the drum clockwise or counterclockwise, thereby tightening or loosening the cable 246.

As shown in FIG. 10, tightening of the cable 246 creates tension in the cable, which pulls the first and second doors 220, 230 inward, thereby locking the doors from the interior of the container 208. More specifically, the tension in the cable 246 pulls the doors 220, 230 from one or more interior surfaces of the container that are not disposed on the doors 220, 230. Additionally, the doors 220, 230 continue to be pulled inward after they are closed. Thus, the cable 246 is not just tensioned to shut the doors and then untensioned. Tension is maintained in the cable 246 to keep the doors closed.

As illustrated, the anchor 268 is connected to the locking mechanism 214c on the interior surface 213 of the side wall 212b and is an e-track strap anchor with D ring. Thus, anchor 268 is movable between the apertures in the locking mechanism 214c to adjust the anchor vertical location of for the pulling device 260. Moreover, the anchor 268 is movable between the locking mechanism 214c and the locking mechanism 214d to adjust horizontally the anchor location for the pulling device 260. However, anchor 268 may have other configurations in other implementations (e.g., a lashing ring or a permanently mounted O-ring).

In certain modes of operation, the anchor 268 is connected to side wall 212b, and the pulling device 260 is connected thereto via coupler 266. In other implementations, the pulling device 260 may be attached directly to an interior surface of the container 208. For example, the pulling device 260 may be mounted to interior surface 213 of side wall 212b or side wall 212a, interior surface 217 of bottom wall 216, or interior surface 219 of top wall 218. In even further implementations, the pulling device may be attached directly to the interior surface of first hinged door 220 or second hinged door 230 if, for example, the cable 246 extended through one or more couplers connected to an interior surface of side wall 212a, side wall 212b, bottom wall 216, or top wall 218 and the cable was reoriented through the coupler to extend from the coupler back toward first hinged door 220 or second hinged door 230. In additional implementations, the pulling device may be connected to one more walls by connecting the distal end of the cable to the pulling device, effectively forming a loop with the cable. The pulling device may rest on the bottom wall 216 of be suspended in mid air in these implementations.

The length of the cable 246 may also vary according to the number of couplers it extends through. For example, the distal end 247 of the cable 246 may be extended from pulling device 260 to a distance much greater than the distance between the side wall 212a and the side wall 212b if cable 246 extends through multiple couplers (see, e.g., FIG. 1). In some implementations, the distance from the distal end 247 to the pulling device 260 may be 25% of the distance between the side walls 212a, 212b, and in other implementations, the distance may be 50%, 100%, or 200% of the distance between the side walls.

The coupler 250 is then connected to the anchor 252, which has already been set in one of apertures 215. Then, the couplers 242, 244 are connected to the anchors 222, 232, respectively, and, if necessary, the cable 246. The person installing the locking system may then leave the trailer. The doors 220, 230 may be closed manually or by activation of the pulling device 260.

Activating the pulling device 260 causes the cable 246 to retract thereinto and increases the tension in the cable 246. This will pull doors toward the interior 211 of the cargo container 208 (if they have not already been closed). Additionally, the pulling device may continue retracting the cable 246 after the doors 220, 230 are closed to further pull the doors toward the interior 211 of the cargo container. This pulling of the doors 220, 230 even after they are closed may be maintained until it is time to open the doors and helps to prevent the doors from being opened even if external locks are compromised.

If need be, the location of the anchor 252 and/or the anchor 268 may be adjusted by moving them to different apertures in the respective locking mechanisms 214a, 214c or moving them to different locking mechanisms, like 214b or 214d. Thus, the amount of inward force on the doors 220, 230 may be adjusted. Typically, moving either anchor 252 or anchor 268 forward in the cargo container 208 toward the front wall 210 will increase the pulling force on the doors 220, 230, and moving either anchor back in the cargo container 208 will decrease the pulling force on the doors 220, 230.

When the cargo container 208 arrives at its destination (or needs to be checked during transport), the pulling device 260 can be activated to lessen the tension in the cable 246 such that one of the doors 220, 230 may be opened wide enough for a user to access the interior 211. Once inside, a user may decouple the cable 246 from the anchor 252 and/or anchors 222, 232 to further open the doors 220, 230.

Although FIG. 10 illustrates an example locking system 200, other locking systems in accordance with the present invention could include fewer, additional, different and a different arrangement of components. For example, the side walls of the cargo container may include lashing rings instead of anchor mechanisms. Thus, the connecting points for the cable 246 may be limited. Additionally, a cargo container may only include one hinged door. Moreover, a door may swing down or up, instead of to the side as illustrated.

Furthermore, the cable 246 may only be connected to one of doors 220, 230. In particular cargo containers, for example, a portion of one door overlaps with a portion of another door when closed. Thus, it is very difficult to open the overlapped door when the non-overlapped door is closed. In these implementations, the cable 246 may not need to be connected to the overlapped door as being connected to the non-overlapping door may provide sufficient security.

In implementations that require enhanced security, a number of on-door anchors (e.g., 4, 6, or 8) could be used on each door. The cable 246 could be laced through all of these anchors, along with one or more possible redirecting anchors on the walls of the cargo container, and then tensioned.

Additionally, although being illustrated as being connected to the side walls 212a, 212b, the cable 246 and the pulling device 260 could be connected to other points within the interior 211 of the cargo container 208. For example, the cable 246 and/or the pulling device 260 could be connected to the bottom wall 216 and/or the top wall 218 of trailer. Thus, there are a variety of configurations by which to implement the inventive concept.

It should be noted that the present invention contemplates any pulling device that can put under tension a cable that is connected to at least one hinged door and at least one interior surface of the container that is not disposed on the at least one hinged door. For example, other types of winches or other types of tensioning devices (e.g., an electronic come-along, hoist, etc.) are within the scope of the present invention.

Additionally, the present invention contemplates different methods of communication with the pulling device 260. For example, while a radio frequency (RF) transmitter and receiver will suffice, other wireless communication protocols (e.g., Bluetooth, WiFi, Infrared, Ultra-Wideband, cellular, etc.) can also be used. However, the invention may need to be adapted to suitably work with other wireless technologies such as, for example, placing an Infrared receiver on the exterior of the shipping container to achieve the appropriate line of sight for communication. Additionally, wired communication to the receiver is also contemplated, in which case, a communication port (not shown) could be installed on the exterior of the cargo container, with a wired connection extending between the communication port and the pulling device.

Further, the present invention contemplates a cargo container in its broadest sense. The term cargo container refers to any container with at least one hinged door that is used to transport goods over land such. For example, the present invention contemplates use on intermodal shipping containers, whether ISO compliant or not, dry van semi-trailers, and other types of ship/train/truck/plane transportable cargo containers.

The present invention has been described in terms of a number of specifically described embodiments, which are presented for purposes of illustration and not of limitation. Moreover, a number of other embodiments have been mentioned or suggested, and those or ordinary skill in the art will readily recognize a number of alternative embodiments (e.g., through addition, deletion, substitution, or transformation of components) not specifically described herein can be used in achieving a locking system and method for a cargo container. Thus, the scope of protection should be judged based on the following claims, which may incorporate one or more aspects of one or more embodiments.

1. A locking system for a cargo container with an interior, an exterior, and at least one hinged door, said lock system comprising:
at least one cable connected to the at least one hinged door and to at least one interior surface of the container, said at least one interior surface not being disposed on the at least one hinged door; and
a pulling device that puts the at least one cable under tension between the connection of the at least one cable to the at least one hinged door and the at least one interior surface of the container.

2. The locking system of claim 1 wherein the at least one cable is connected to the at least one hinged door through at least one on-door anchor and is connected to the at least one interior surface of the container through at least one off-door anchor.

3. The locking system of claim 2 wherein the at least one on-door anchor comprises a plurality of on-door anchors and the at least one off-door anchor comprises a plurality of off-door anchors.

4. The locking system of claim 2 wherein a first cable extends from the pulling device and has a distal end extendable from the pulling device and retractable toward the pulling device and wherein the locking system further comprises:
a first coupler adapted to connect the first cable to a first on-door anchor on a first hinged door of the container; and
a second coupler adapted to connect the distal end of the first cable to a first off-door anchor.

5. The locking system of claim 4, further comprising a second cable connected to the pulling device and a third coupler adapted to connect the second cable to a second off-door anchor.

6. The locking system of claim 5, further comprising a fourth coupler adapted to connect the first cable to a second on-door anchor on a second hinged door of the container.

7. The locking system of claim 5, wherein the second coupler is selected from the group consisting of a spring link, a chain quick link, a hook, an S-hook, and an eye & jaw swivel.

8. The locking system of claim 6, further comprising:
a fifth coupler adapted to connect the first cable a third off-door anchor;
a sixth coupler adapted to connect the first cable to a third on-door anchor on the second hinged door; and
a seventh coupler adapted to connect the cable to a fourth on-door anchor on the first hinged door.

9. A locking system for a cargo container with an interior, an exterior, and at least one hinged door, said locking system comprising:
a pulling device in the interior of the container,
at least one cable extending from the pulling device and connected to the at least one hinged door; and
wherein the pulling device is positioned to put the at least one cable under tension to pull the at least one hinged door toward the interior of the container after the at least one hinged door is closed.

10. The cargo container locking system of claim 9 wherein the at least one cable is connected to at least one interior surface of the container, said at least one interior surface not being disposed on the at least one hinged door.

11. The cargo container locking system of claim 10, wherein the at least one cable is connected to the at least one hinged door through at least one on-door anchor and is connected to the at least one interior surface of the container through at least one off-door anchor.

12. The cargo container locking system of claim 11, wherein the at least one on-door anchor comprises a plurality of on-door anchors and the at least one off-door anchor comprises a plurality of off-door anchors.

13. A cargo container locking system, the locking system comprising:
a cargo container comprising a front wall, a first side wall, a second side wall, a top wall, a bottom wall, and at least one hinged door opposite the front wall, wherein the front wall, the first side wall, the second side wall, the top wall, the bottom wall and, when closed, the at least one hinged door define an interior for the container;
a pulling device in the interior of the container,
at least one cable extending from the pulling device and connected to the at least one hinged door; and
wherein the pulling device is positioned to put the at least one cable under tension to pull the at least one hinged door toward the interior of the container after the at least one hinged door is closed.

14. The cargo container locking system of claim 13 wherein the at least one cable is connected to at least one interior surface of the container, said at least one interior surface not being disposed on the at least one hinged door.

15. The cargo container locking system of claim 14, wherein the at least one cable is connected to the at least one hinged door through at least one on-door anchor and is connected to the at least one interior surface of the container through at least one off-door anchor.

16. The cargo container locking system of claim 15, wherein the at least one on-door anchor comprises a plurality of on-door anchors and the at least one off-door anchor comprises a plurality of off-door anchors.

17. A method for locking a cargo container with an interior, an exterior, and at least one hinged door, said method comprising maintaining pulling force on the at least one hinged door to pull the at least one hinged door toward the interior of the cargo container after the door is closed.

18. The method of claim 17 further comprising:
connecting a cable that extends from a pulling device to the at one least hinged door; and
putting the cable under tension to pull the at least one hinged door toward the interior of the cargo container after the door is closed.

19. The method of claim 18 further comprising connecting the cable to at least one interior surface of the cargo container that is not disposed on the at least one hinged door.

20. The method of claim 19:
wherein connecting a cable to the at one least hinged door of a cargo container and to at least one interior surface of the container that is not disposed on the at least one hinged door comprises extending the cable through a first coupler adapted to connect the cable to the at least one hinged door and coupling a distal end of the cable to the at least one interior surface of the container; and
wherein applying tension to the cable to pull the at least one hinged door toward the interior of the shipping container after the at least one hinged door is closed comprises activating the pulling device located in the interior of the cargo container.

21. The method of claim 20 further comprising extending the cable through a second coupler adapted to connect the cable to a second hinged door of the cargo container.

22. The method system of claim 21, wherein the cable pulls the second door toward the interior of the container after the at least one hinged door is closed.

23. The method of claim 22 further comprising extending the cable through a third coupler adapted to connect the cable to an interior surface of a cargo container that is not disposed on the at least one hinged door, said third coupler being adapted to change the direction of the cable before extending the cable through the first coupler.

24. The method of claim 23 further comprising:
extending the cable through a fourth coupler adapted to connect the cable to the second hinged door at another location on the second hinged door; and
extending the cable through a fifth coupler adapted to connect the cable to the first hinged door at another location on the first hinged door.

25. The method of claim 24 further comprising extending the cable through a sixth coupler adapted to change the direction of the cable before extending the cable through the fourth coupler.
